(19) United States
(12) Patent Application Publication
(10) Pub. No.: US 2005/0099932 A1
(43) Pub. Date: May 12, 2005

(54) Information recording/reproduction head

(76) Inventor: Masahiro Yanagisawa, Tokyo (JP)

Correspondence Address: KATTEN MUCHIN ZAVIS ROSENMAN, 575 MADISON AVENUE, NEW YORK, NY, 10022-2585, US

(21) Appl. No.: 11/010,692

(22) Filed: Nov. 29, 2004

(30) Foreign Application Priority Data
May 29, 2002 (JP) 2002-155503

(51) Int. Cl. G11B 7/00

(52) U.S. Cl. 369/112.01

(57) ABSTRACT

An information recording/reproduction head has a slider (8) having a rail (10) provided with a groove (11), which is coated with a hydrophilic surface treatment agent (12). The rail (10) is provided at a corner thereof with a part having a radius of curvature smaller than the half diameter of a dust cluster multiplied by a predetermined constant. No dust is allowed to adhere to the head when the recording medium is driven to revolve. Dust is prevented from adhering to the surface of the recording medium and entering the gap between the head and the recording medium.

### TECHNICAL FIELD

This invention relates to a head for optically or magnetically recording information, reproducing information from and erasing information from an information recording medium. More particularly, it relates to an information recording/reproduction head that can record, reproduce and erase information with an enhanced degree of density and mechanical reliability.

### BACKGROUND ART

Technological developments are under way for disk type information recording/reproducing systems that typically use magnetic disks and optical disks in order to provide them with a higher capacity and a higher recording density, although image compression technologies remarkably advanced in recent years. Although optical disks allow a relatively high data recording density a higher recording density is desired for them. A smaller light spot can realize a higher data recording density on the optical recording medium. However, the recording density is limited by the diffraction limit of the light spot on the recording medium. When a lens or a far field focusing device is used to focus a light beam onto the surface of a recording medium, the size of the converged light spot at the focal point faces a limit of λ/2 (λ being the wavelength of light) due to diffraction. This is referred to as diffraction limit.

To raise the recording density above the current density level, it is necessary to reduce the size of the light beam emitted to write or read information. Near field optical technologies that exploit the characteristics of the low phase velocity of an evanescent wave have been attracting attention as possible breakthrough in the diffraction limit. These technologies are intended to optically read/write information by means of an optical element that transmits an evanescent wave having a short wavelength through an aperture, which is smaller than the wavelength and formed in a metal film.

Recently, there has been disclosed an optical transmission technology that remarkably raise the transmittance of light being transmitted through an aperture cut through a metal film with a diameter smaller than the wavelength of light, by providing the surface profile of the metal film with projections and recesses that are cyclically arranged near the aperture (Japanese Patent Laid-Open Publication No. 2000-291265). The optical recording system using an optical head having an optical element realized by using a metal film is drawing attention as a system that allows high density recording because it can write information in an area smaller than the wavelength of light.

FIG. 11A schematically illustrates a read/write head 100 for writing information on an optical storage medium 150 and reading information from the optical storage medium 150. The read/write head 100 includes a waveguide 110 and an optical element 120 formed by using a metal film having an aperture with a diameter smaller than the wavelength of light and a surface profile with projections and recesses that are cyclically arranged near the aperture as described above. The waveguide 110 is arranged to lead light to the optical element 120. The optical element 120 is arranged on the corresponding end facet 112 of the waveguide 110 so that light proceeds either from the waveguide 110 toward optical storage medium 150 or inversely from the optical storage medium 150 toward the waveguide 110. Regardless of the moving direction of light, the optical element 120 raises the intensity of light transmitted therethrough. The optical element 120 has a metal film 122 that is preferably made of silver and has an aperture 130 cut therethrough. The size of the aperture 130 cut through the metal film 122 defines the resolution of the device.

The aperture 130 has a diameter of d, which is not larger than the wavelength of light that enters the aperture 130. The read/write head 100 is lifted from the optical storage medium 150 by a distance smaller than the diameter of the aperture or held in contact with the optical storage medium 150 when it writes information on or read information from the storage medium. The metal film 122 of the optical element 120 has a cyclic surface topography 140 at least on one of its two surfaces. Typical examples of the cyclic surface topography 140 include one as illustrated in FIG. 11B that shows a square lattice arrangement of small recesses or semispherical projections and those having a set of concentric annular undulations as illustrated in FIGS. 11C and 11D. By using such a cyclic surface topography 140, light incident onto one of the surfaces of the metal film is transmitted through and amplified by the aperture of the metal film.

While optical write/read heads formed by using such an optical element are expected to realize a higher information storage density than ever, they are accompanied by problems that are different from the problems of known optical heads using a far field optical system and adapted to operate with a distance separating the optical head and the storage medium. Examples of the problems of optical heads using such an optical element include that dust and/or scraped particles can enter and fill the micro-aperture and/or the recesses of the cyclic topology formed on the optical element and that the aperture and/or the recesses are scarred to hinder normal recording/reproducing operations because the optical head is lifted only slightly from or held in contact with the storage medium for writing/reading operations and seek operations for tracking signals. These problems are common to both optical disks and magnetic disks. These problems have been discussed frequently particularly in the case of magnetic disk heads adapted to be lifted from or held in contact with the storage medium from the viewpoint that the head that is lifted from or held in contact with the storage medium for operation can crush the storage medium by way of dust and/or scraped particles.

Japanese Patent Laid-Open Publication No. 11-273046 describes a structure, for seizing dust during a seek operation, formed by arranging a step on the lateral surfaces of a magnetic head slider. However, a simple step can attract dust only weakly and hence the attracted dust can easily fall onto the surface of the recording medium and give rise to abrasion and recording/reproduction errors when the slider vibrates. Japanese Patent Laid-Open Publication No. 5-081810 describes a structure formed by arranging a groove on the buoyancy generating surface of a magnetic head slider rail and upwardly tilting the surface linked to the flow-in edge of the groove toward the flow-in edge so as to attract dust to the inclined surface. However, with such a structure, it is not possible to prevent dust from reaching the surface of the slider rail nor is it possible to attract the effect of attracting dust. Japanese Patent Laid-Open Publication No. 4-137286 describes a structure for releasing dust far away from the surface of a recording medium by tapering the front end surface of a magnetic head slider to make it form an acute angle with the guide surface. However, with such a structure formed only by tapering the front end surface of a magnetic head slider, the released dust can, if partially, return and fall on the surface of the recording medium as the slider vibrates Japanese Patent Laid-Open Publication No. 5-159503 discloses a structure formed by arranging a dielectric substance such as ebonite, resin or silicon around a magnetic head slider so as to attract dust by electrostatic force. However, with such an arrangement, the obtained attracting power is small and it is difficult to strongly hold dust. Additionally, the attracting power can fluctuate depending on the environmental conditions and hence is unstable.

### DISCLOSURE OF THE INVENTION

In view of the above identified problems of known information recording/reproduction heads for optical or magnetic recording/reproduction that are adapted to be lifted from or held in contact with a recording medium, it is therefore an object of the present invention to provide an information recording/reproduction head that can prevent dust from entering into the gap between the floating slider or the contact slider of the head and a recording medium and from falling onto the recording medium.

The present invention provides, in a first aspect thereof, an information recording/reproduction head for recording information on or reproducing information from a rotary disk, characterized by: a slider adapted to be floated above or held in contact with the disk for traveling, the slider having an organic substance layer, arranged at a surface region thereof in a vicinity of the disk, for attracting dust on the disk so as to collect the dust.

In a preferred embodiment of the information recording/reproduction head of the first aspect of the present invention, the slider has a positive pressure surface for floating thereby or a contact pad for contacting thereby, and a groove, on a lateral surface having an angle with a disk-opposing surface of the positive pressure surface or contact pad, for collecting and holding the dust existing on the disk, the organic substance layer being formed by coating on the groove.

The present invention provides, in a second aspect thereof, an information recording/reproduction head for recording information on or reproducing information from a rotary disk, characterized by: a slider adapted to be held in contact with the disk for traveling, the slider having a lateral surface forming an angle with a disk-opposing surface of a contact pad for the contacting, the lateral surface mounting thereon an organic substance layer for attracting thereon dust existing on the disk so as to collect the dust, wherein a ridge formed by the lateral surface and the disk-opposing surface has a radius of curvature smaller than a value obtained by multiplying a half diameter of particles of the dust existing on the disk and forming clusters by a predetermined constant.

The present invention provides, in a third aspect thereof, an information recording/reproduction head for recording information on or reproducing information from a rotary disk, characterized by: a slider adapted to be held in contact with the disk for traveling, the slider having a contact pad for the contacting, the contact pad having a lateral surface forming an angle with a disk-opposing surface thereof, the lateral surface having thereon a groove for collecting and holding dust existing on the disk, the groove having a layer of an organic substance formed therein for attracting dust for adhesion, wherein a ridge formed by the lateral surface and the disk-opposing surface has a radius of curvature smaller than a value obtained by multiplying a half diameter of particles of the dust existing on the disk and forming clusters by a predetermined constant.

In the information recording/reproduction head of the second and second aspects of the present invention, due to having the configuration as described above, the dust scattering on the recording medium is collected in the groove. The dust collected in the groove can be made to hardly fall back onto the recording medium. The organic substance layer takes a role of holding the dust and anchoring the dust to the slider. Preferably, the organic substance layer should be made to rigidly adhere to the lateral walls of the recessed section of the positive pressure surface and/or that of the contact pads, and exhibit affinity for the dust there and the lubricating oil mixed therewith and also hydrophilicity so that it can prevent crumbs of dust from peeling off from the positive pressure surface and the lateral walls of the contact pads etc. of the slider and falling down therefrom.

The organic substance is expressed by chemical formula of (G-R1)ₓSi(OR)₄₋ₓ, where R1, R and x represent a hydrophilic functional group, a hydrocarbon chain an integer selected from 1, 2 and 3, respectively. In addition, G represents a hydrophilic functional group selected from hydrophilic functional groups including OH—(hydroxyl group), NH₃—(amino group), HC(—O—)═CH—(glycidoxy group) and —NCO(isocyanate group), R represents a hydrocarbon chain and R represents a reactive functional group selected from reactive functional groups including —CH₃, —C₂H₅ and —H. The hydrogen bond functional group attracts functional groups, existing on the surfaces of dust clusters and along the terminal parts of lubricant with a strong intermolecular force. The reactive functional group gives rise to a chemical reaction with dust and/or lubricant to form a very strong covalent bond. The hydrophilicity that arises due to the hydrogen bond and the chemical reactivity relative to dust provides an effect of binding the organic substance to clusters of dust and lubricant more firmly if compared with hydrocarbons and fluorinated hydrocarbons that are hydrophobic and not hydrophilic.

It is preferable that, among the above heads, the information recording/reproduction head having a contact pad on the slider further include a support spring for supporting the slider, wherein assuming a force by which the support spring is pressed against the slider is W, a distance between a pressure application point at which the support spring presses the slider and a rearmost contact point at which the contact pad contact the disk is L₁, a distance between a contact point at which a dust cluster contacts the contact pad and the rearmost contact point is L₂ a frictional force applied by the dust cluster to the contact point is Fh, and a variable conversion of A=(WL₁/FhL₂)² is made, given B as expressed by the formula of B=2A+1+(4A(A+1))^{1/2} is the predetermined constant.

Each of all the predetermined constants as described above preferably has a value within a range between 2.6 and 36,000,000. Therefore, if the positive pressure surface or contact pad has a corner having a curvature of radius r which is smaller than the half diameter g of the dust cluster multiplied by B, it is possible to prevent the dust from coming onto the floating surface.

In addition in each of all the information recording/reproduction heads, the disk may be a disk for use in optical recording/reproduction, and the contact pad or the positive pressure surface is provided, on a disk-opposing surface thereof, with an optical element for raising an intensity of light transmitted through the micro-aperture.

In each of all the information recording/reproduction heads as describe above, the disk is preferably a disk for use in magnetic recording/reproduction, and the contact pad or the positive pressure surface is provided, on a disk-opposing surface thereof, with a magnetic recording/reproduction element.

### BRIEF DESCRIPTION OF THE DRAWINGS

FIG. 1 Is a schematic side view of the first embodiment of information recording/reproduction head according to the present invention;

FIG. 2 is a schematic perspective view of the slider of the information recording/reproduction head of FIG. 1, showing the side thereof that faces the recording medium;

FIG. 3 is a schematic perspective view of the slider of the second embodiment of information recording/reproduction head, showing the side thereof same as that of FIG. 2;

FIGS. 4A, 4B and 4C are a top plan view, a side view and a rear end view, respectively, of the slider of the third embodiment of information recording/reproduction head, showing the side thereof that faces the recording medium;

FIG. 5 is a schematic diagram showing the chemical structure of the surface treatment layer formed in the recesses of the contact pads and the mode of holding dust clusters or lubricant molecules of the second embodiment of information recording/reproduction head;

FIGS. 6A and 6B are a sectional view and a detailed partial view thereof of a part of the second embodiment of information recording/reproduction head that holds dust;

FIGS. 7A, 7B and 7C are schematic sectional views of the second embodiment of information recording/reproduction head, illustrating the relationship between a corner section of a contact pad and the size of a particle of dust;

FIG. 8 is a schematic side view of the second embodiment of information recording/reproduction head accompanied by arithmetic formulas for expressing the conditions to be met in order to prevent dust from entering the gap between the head and the recording medium;

FIG. 9 is a graph illustrating the particle diameter distribution of dust clusters;

FIGS. 10A through 10F are schematic sectional views of an information recording/reproduction head according to the present invention in different manufacturing steps; and

FIG. 11A is a schematic sectional view of a known read/write head using a metal film having a micro-aperture and FIGS. 11B through 11D are schematic top plan views of different front ends that can be used for the head.

### BEST MODE FOR CARRYING OUT THE INVENTION

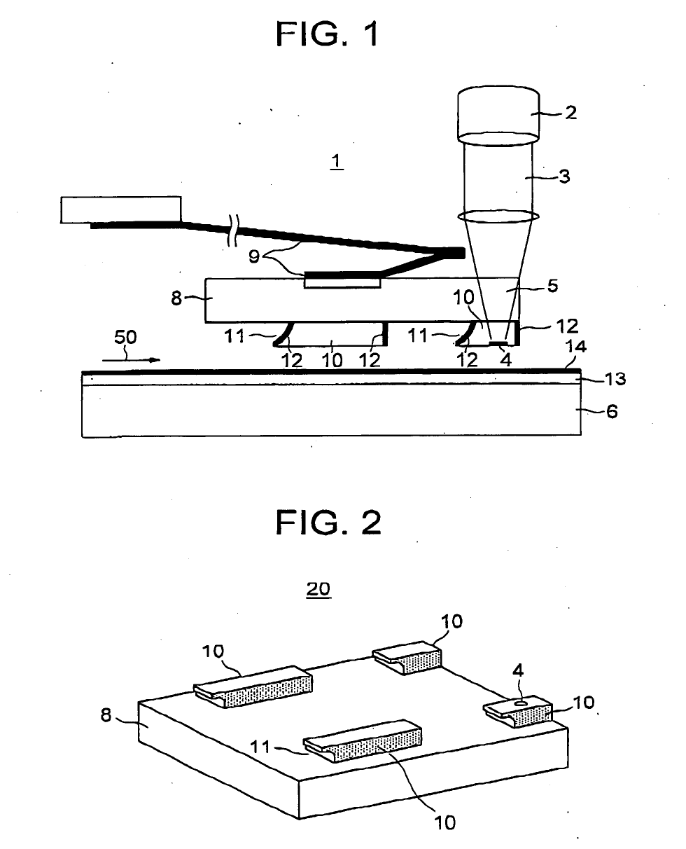

Now, the present invention will be described in greater detail by referring to the accompanying drawings that illustrate preferred embodiments of the present invention. FIG. 1 illustrates the configuration of an information recording/reproduction head according to a first embodiment of the present invention, which is an optical head. The information recording/reproduction head is an optical head including an optical element formed by using a metal film having therein an aperture with a diameter smaller than the wavelength of light and a surface profile with projections and recesses that are cyclically arranged near the aperture. The optical head 1 leads a beam of light 3 from a light source 2 to the optical element 4 by way of a waveguide 5 so as to write information on or read information from an optical disk recording medium 6 that is formed by coating a substrate 7. Arrow 50 in FIG. 1 indicates the moving direction of the optical disk recording medium 6.

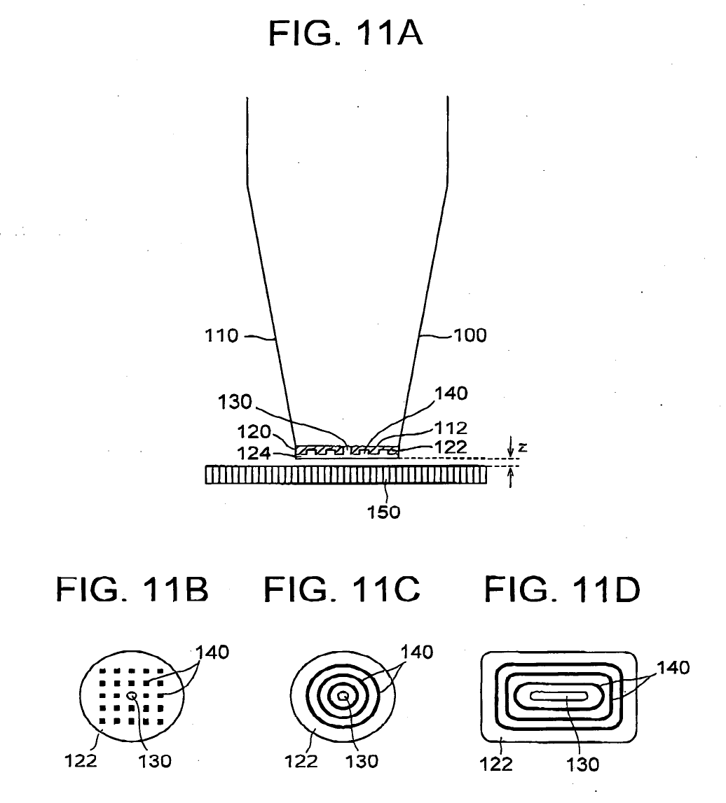

The optical head 1 has a slider 8 and a support spring. The slider 8 is provided with a rail 10 configuring an air bearing surface for floating the optical head 1 in air above the recording medium 6, with the intervention of the protection film 13 and the lubricating film 14 of the recording medium. In short, the optical head of the present embodiment is a floating type head. FIG. 2 illustrates the slider 8 of the information recording/reproduction head of the present embodiment, showing the configuration on the side thereof that faces the recording medium. The rail 10 may be a single and continuous piece or may be divided into a number of pieces in the illustrated example, the rail 10 is divided into four pieces. The optical element 4 is arranged on the floating surface of one of the pieces of the rail. The optical element 4 has a profile similar to any of the possible profiles of the known element illustrated in FIGS. 11B, 11C and 11D.

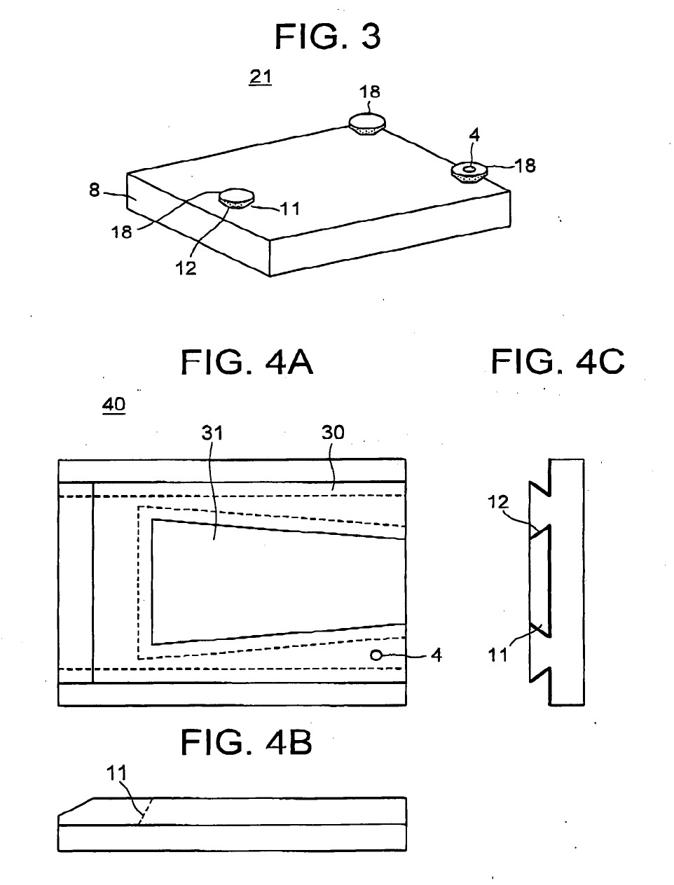

FIG. 3 illustrates the slider of an information recording/reproduction head according to a second embodiment of the present invention, showing the side thereof that faces the recording medium. The slider in the present embodiment differs from that of FIG. 2 in that three contact pads 18 are arranged separately instead of the rail 10 for floating. The pads have a structure adapted to directly contact the recording medium. More specifically, the optical head of the present embodiment is a contact type head. An optical element 4 is arranged on the surface of one of the pads that contact the recording medium.

FIGS. 4A through 4C illustrate the slider an information recording/reproduction head according to a third embodiment of the present invention, which is of a negative pressure type. A force that floats the slider is applied to positive pressure surface 30 while a force that attracts the slider to the surface of the recording medium is applied to negative pressure surface 31. A floating amount that minimizes the speed dependency thereof is obtained when the two forces are balanced.

The head of each of the above-described embodiments is additionally provided with grooves or recesses for seizing dust and, preferably, a surface treatment layer is formed in the grooves or the recesses. More specifically, in the case of the floating type slider 20 or the first embodiment, a recess 11 is formed in each piece of the rail 10 of the slider 8, as shown in FIG. 2, and a surface treatment layer 12 is formed on the end facets of each piece of the rail 10 including the recess, as shown in FIG. 1. In the case of the contact type slider 21 of the second embodiment, a recess 11 is formed on the lateral surface of each of the contact pads 18 and a surface treatment layer 12 is arranged on this recess, as shown in FIG. 3. Further, in the case of the negative pressure type slider 40 of the third embodiment, a groove 11 is formed on the negative pressure surface 31 and a surface treatment layer 12 is formed on the lateral surfaces of the groove and on the bottom surface of the groove that is the positive pressure surface, as shown in FIG. 4.

The recesses and the surface treatment layers take respective roles as described below. As the slider starts running on or above the recording medium, the particles of dust that are scattered on the recording medium are collected in the grooves or the recesses 11. The capacity of the grooves or the recesses is made larger than the volume of the dust. Therefore, the particles of dust collected in the grooves or the recesses can hardly fall back onto the recording medium 6. However, some of them may fall thereon if the slider is subjected to an excessively large acceleration. A surface treatment layer is arranged on each of the recesses in order to prevent the dust from falling. The surface treatment layer 12 takes a role of holding particles of dust and anchoring them to the slider. The surface treatment layer rigidly adheres to the lateral walls of the positive pressure surface or those of each of the contact pads and has affinity for dust and the lubricant that is mixed with the dust and hydrophilicity so that it prevents dust clusters from peeling off and falling from the rail or the lateral walls of the recesses of the contact pads or the similar components.

Preferably, the surface treatment agent that forms the surface treatment layer is expressed by the following chemical formula:
(G-R1)ₓSi(OR)₄₋ₓ,
where x represents an integer selected from 1, 2 and 3 and G represents a hydrophilic functional group that may be a hydrogen bond functional group such as OH—(hydroxyl group) or NH₃—(amino group) or a chemically reactive functional group such as HC(—O—)═CH—(glycidoxy group) or —NCO(isocyanate group). Hydrogen bond functional groups and the functional groups, which exist on the surface of the dust clusters and at the terminals of the lubricant, attract each other with a strong intermolecular force. Chemically reactive functional groups react with dust and lubricants to form a very strong covalent bond.

The hydrophilicity that arises from the hydrogen bond and the chemical reactivity with dust is quantified by the number of inorganic groups as described in Japanese Patent No. 288490 and provides an effect of binding dust clusters and lubricants to the surface treatment agent more firmly, if compared with hydrocarbons and fluorinated hydrocarbons that are hydrophobic and not hydrophilic. R1 represents a hydrocarbon chain such as —CₙH₂ₙ— (n being an integer not smaller than 1) and R represents a reactive functional group such as —CH₂, —C₂H₅ or —H that chemically reacts with the slider surface and becomes bonded thereto. The chemical reaction takes place as a result of hydrolysis caused by the moisture adsorbed to the slider or the heat treatment that is conducted at temperature not higher than 300° C. after the application of the surface treatment agent. Then, the SiOR group reacts with water in a manner as expressed by the following formula:
SiOR+H₂O [symbol] SiOH+ROH
and the produced SiOH group reacts with the material M of the slider to produce a bond of SiOM. The reaction becomes less active when the molecular weight of R is too large. In other words, R preferably has a small molecular weight substantially equal to that of —H, —CH₃, —C₂H₅ or —C₃H₇.

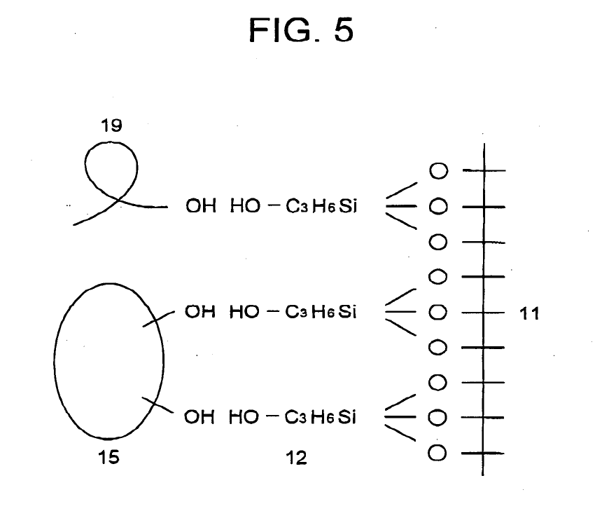

FIG. 5 illustrates a mode in which the surface treatment layer 12 that is formed by a chemical reaction that takes place as a result of applying a surface treatment agent expressed by the above formula, where G is OH—, R1 is —C₃H₆— (n=3) and R is —CH₃, to the surface of the slider is chemically bound to the recesses 11 of the rail or the contact pads so as to hold dust clusters 15 and lubricant molecules 19 or a mixture thereof. Dust clusters are formed as clusters such as carbon particles scraped off from the protection film that used to contain them, particles of silicon dioxide, fiber filaments and metal powder scraped off from some of the components of the mechanism coagulate together and the lubricant is partly mixed with it. Hydrophilic functional groups that exist on the surface of dust clusters and in lubricant molecules adhere to the surface treatment layer by chemical force. Therefore, while any functional group G may be used for the surface treatment agent, the use of a functional group containing oxygen and/or nitrogen is effective. Particularly, the use of a hydroxyl group and/or an amino group is highly effective and the use of a glycidoxy group (epoxy group) and/or an isocyanate group that are chemically highly reactive is most effective.

While R1 is the molecular chain of a hydrocarbon group having one or more than one carbon atoms, the number of carbon atoms is preferably not larger than 10 from the viewpoint of solubility to the solvent at the time of application of the surface treatment agent. The —OR is preferably an —OH group that forms an alkoxy group or a silanol group (—SiOH) that reacts with the optically transparent slider material such as quartz or sapphire. The use of a halogen group such as —Cl is not preferable because such a group is corrosive, although highly reactive. The letter x represents an integer that defines the number of functional groups G and OR groups. The affinity of the surface treatment agent for molecules of the lubricant increases as the value of x increases from 1 to 2 or 3, whereas the number of bonds to the recesses decreases at the same time. Therefore, while the use of 2 for x is best in terms of balance therebetween, a satisfactory effect may be obtained by using 1 or 3 for x.

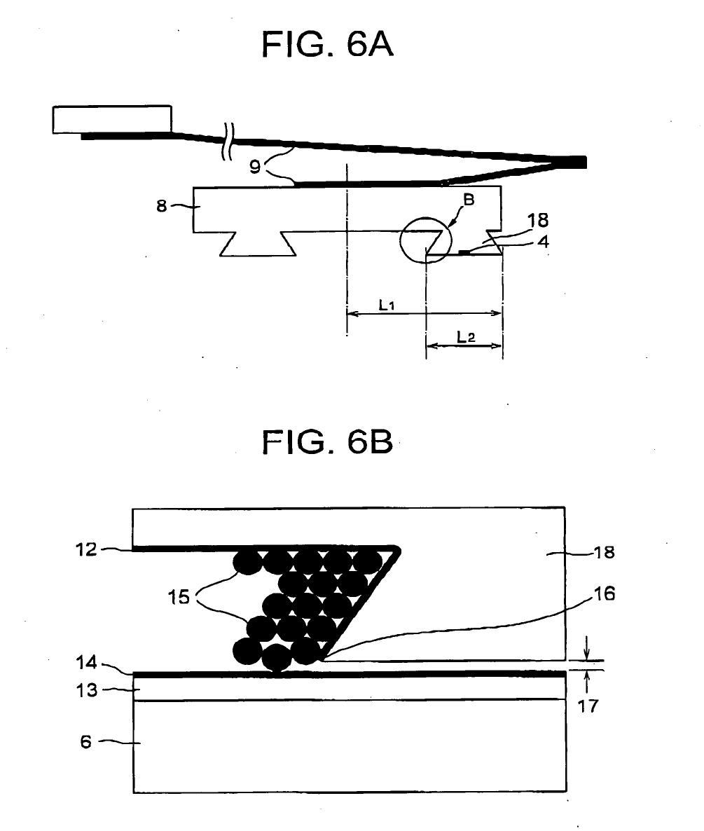

Now, the dynamic conditions that allow dust to enter the gap between the recording medium and the head slider will be discussed below in connection of exemplified contact pads 18. FIG. 6A is a sectional view of the head slider, illustrating the structure thereof, and FIG. 6B is an enlarged view of area B in FIG. 6A, showing in detail how the groove or recess 11 formed at an end of a contact pad 18 collects and holds dust. Dust enters the groove or recess 11 so that particles of dust are prevented from falling onto the surface of optical disk 6. Additionally, particles of dust coagulate to form dust clusters 15.

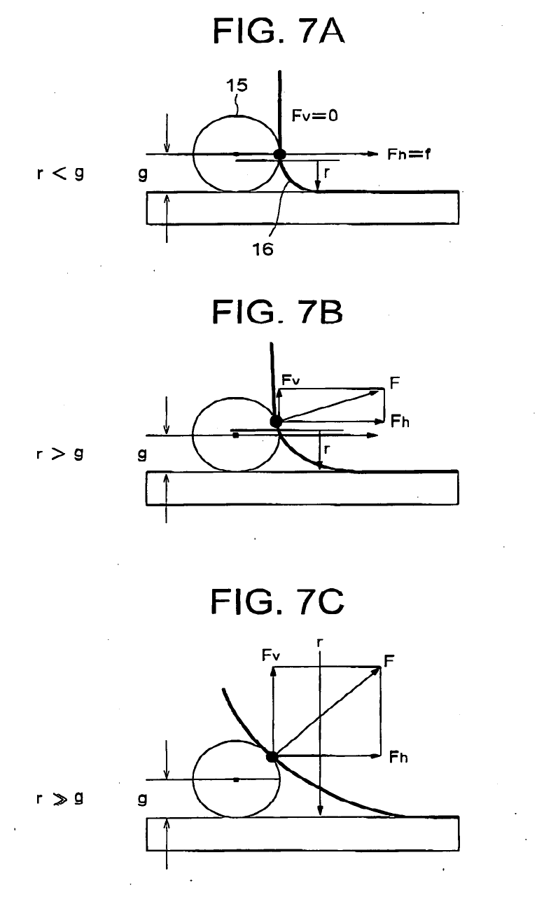

Each of FIGS. 7A through 7C illustrates the corner 16 of the recess of a contact pad that slides on the surface of a recording medium with a gap interposed there between and a dust cluster trying to push up the corner and enter the gap. Assume here that the half diameter of the cluster 15 is g and the radius of curvature of the corner 16 is r. The center of gravity of the cluster is located at the level that is a half of the diameter thereof. If the gap 17 between the contact pad 18 and the surface of the optical disc is smaller than the distance between the surface of the optical disk and the center of gravity, or the half diameter, of the cluster (FIG. 7A), the cluster cannot enter the gap 17. A very large force is required to divide the cluster into smaller clusters of a size less than 10 nanometers because of the interatomic force that maintains the cluster and hence it is practically impossible for a dust cluster having a size less than 10 nanometers to exist under the operating conditions of a magnetic disk or an optical disk. Therefore, no dust cluster can enter the gap between the head and the disk when the gap is smaller than 10 nanometers. On the other hand, if the radius of curvature r of the corner of the contact pad is greater than the half diameter g of the cluster as shown in FIGS. 7B and 7C, there arises a force trying to push up the contact pad so that consequently the contact pad is raised to allow the dust cluster to enter the gap.

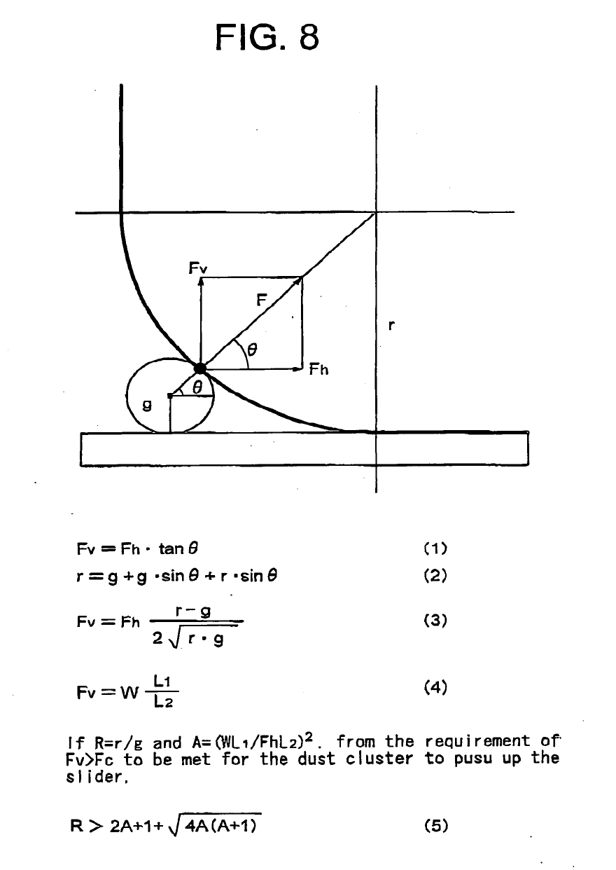

FIG. 8 illustrates the relationship between the radius of curvature r of the corner of the contact pad and the half diameter g of the cluster in greater detail. Assuming that the force that the cluster applies to the contact pad is F, the angle formed by the vector of the force and the level is θ, the component of the force F in the running direction of the head is Fh, and the component of the force F in the vertical direction is Fv, the following relationships hold:
Fv=Fh·tan θ (1) and
r=g+g·sin θ (2),
so that consequently the following equation is obtained:
Fv=Fh·(r−g)/(2(r·g)^{1/2}) (3).
On the other hand, assuming that the force by which the support spring is pressed against the contact pad is W while the distance from the corner at the rear and of the contact pad to the pressure application point of the support spring is L₁ and the distance from the contact point at the rear end to the corner where the cluster contacts the contact pad is L₂ as shown in FIG. 6A, the force Fc by which the slider tries to push down the cluster is expressed, using the moment L₂×Fc that is applied to the cluster, by the following formula;
Fc=W·L₁/L₂ (4).

Thus, the cluster pushes up the slider and enters the gap between the contact pad and the optical disk when there arises a combination of r and g that satisfies the conditions under which the force Fc is greater than Fc of the formula (4).

When the following substitutions of
R=r/g and A=(WL₁/FhL₂)²
are used, the requirement that needs to be met for Fv>Fc is expressed by the following formula:
R<2A+1±(4A(A+1))^{1/2} (5)
Thus, the dust cluster pushes up the slider and enters the gap between the contact pad and the optical disk when the above requirement is met.

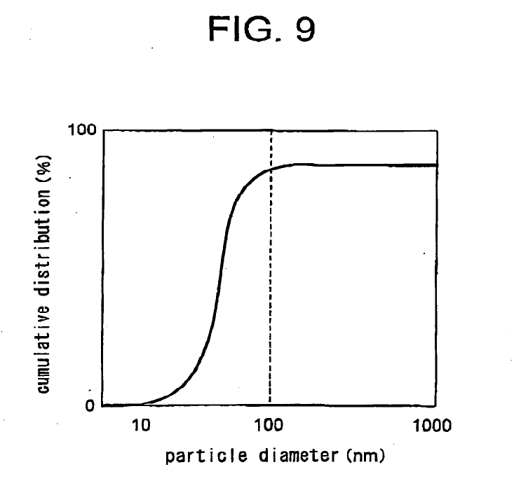

If W is 5 grams and Fh is 1 gram, while L₁ is 3 mm and L₂ is 1 mm, the ratio R of the half diameter of the dust cluster to the radius of curvature is 902. Thus, when the rail 10 or the contact pad is made to have a corner with a radius of curvature r that is smaller than the half diameter g of the dust cluster multiplied by 902, the dust cluster is prevented from coming onto the floating surface. Dust clusters show a cumulative distribution pattern as shown in FIG. 9. Most clusters are larger than 100 nm and only less than 0.1% of clusters have a size less than 10 nm. Therefore, if 2 g is made equal to 10 nm, the value of R is found between 2.6 and 36,000,000 because the radius of curvature of the corner is 4.5 μm and the ratio of L₁ to L₂, or (L₁/L₂), of an ordinary head is between 0.5 and 300, while W is between 0.5 grams and 15 grams and Fh is between 0.05 grams and 15 grams. Thus, from the cluster size distribution of FIG. 9, the radius of curvature of the corner that can prevent the smallest dust cluster from entering the gap is between 26 nm and 360 nm.

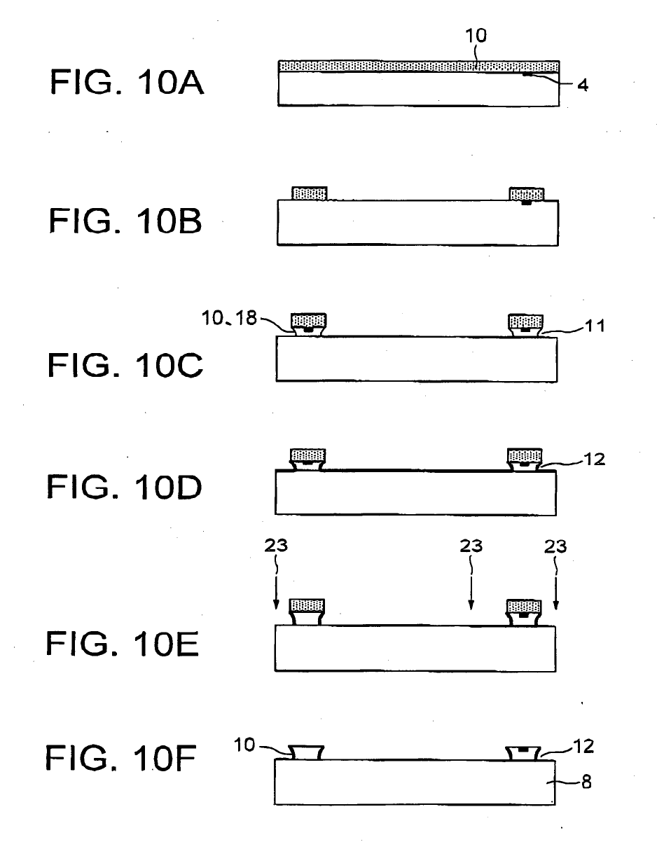

FIGS. 10A through 10F illustrate an information recording/reproduction head according to the present invention in different manufacturing steps. An optical element 4 is arranged in the substrate of an optically transparent slider 8 that is typically made of quartz or sapphire and photoresist 22 is applied to the top surface of the substrate (FIG. 10A) The parts of the photoresist that make contact pads are exposed to light and the remaining part of the photoresist is removed by chemical etching or ion etching (FIG. 10B). Thereafter, rails 10 or contact pads 18 having recesses 11 are formed by chemical etching (FIG. 10C). Then, the top surface of the substrate is coated with a surface treatment agent as described below by means of a dipping method (FIG. 10D) and the coat is etched by means of ion beams 23 (FIG. 10E). As a result, an optical head is formed with a surface treatment layer 12 left on the lateral surfaces of the contact pads (FIG. 10F). Note, however, the step E may be omitted because the surface treatment layer may be left on the processed surface of the slider without giving rise to any problem.

While the use of an optical element formed by using a metal film having an aperture with a diameter smaller than the wavelength of light and a surface profile with projections and recesses that are cyclically arranged near the aperture is described above for the above embodiment, an optical head formed by means of near field optical technologies of using evanescent wave and a metal film having an aperture with a diameter smaller than the wavelength of light but not any surface profile may alternatively be used. Additionally, while the above embodiments are described in connection with an optical head using an optical element, it is apparent that the technological concept of the present invention encompasses the use of a magnetic head.

Thus, as described above, in a floating type or contact type information recording/reproduction head according to the present invention, the slider or each of the contact pads or the rail of the slider is provided at the front end or the rear end and/or the lateral surfaces thereof with a groove or recess cut perpendicularly relative to the surfaces in order to anchor the adhering dust and a surface treatment agent is selectively used to strengthen the bond between the dust on the surface treatment layer and the slider or the contact pads or the rail of the slider in order to prevent dust from falling onto the surface of the recording medium. Additionally, the gap between the slider and the recording medium is so arranged as to prevent dust from entering there. Thus, the dust adhering to the contact pads is physically and chemically held there and prevented from moving and adhering onto the recording medium.

1. An information recording/reproduction head for recording information on or reproducing information from a rotary disk, characterized by:
a slider adapted to be floated above or held in contact with the disk for traveling, said slider having an organic substance layer, arranged at a surface region thereof in a vicinity of the disk, for attracting dust on the disk so as to collect the dust.

2. The information recording/reproduction head according to claim 1, wherein said slider has a positive pressure surface for floating thereby, said positive pressure surface having a groove for collecting and holding the dust existing on the disk, said organic substance layer being formed by coating at least in said groove.

3. The information recording/reproduction head according to claim 1, wherein said slider has a contact pad for contacting thereby, said contact pad having a lateral surface forming an angle smaller than 90 degrees with an opposing surface of the disk, said lateral surface being provided with a groove for collecting and holding the dust existing on the disk, said organic substance layer being formed by coating at least in said groove.

4. An information on or reproducing information from a rotary disk, characterized by:
a slider adapted to be held in. contact with the disk for traveling, said slider having a. lateral surface forming an angle with a disk-opposing surface of a contact pad for said contacting, said lateral surface mounting thereon an organic substance layer for attracting thereon dust existing on the disk so as to collect the dust, Wherein a ridge formed by said lateral surface and said disk-opposing surface has a radius of curvature smaller than a value obtained by multiplying a half diameter of particles of the dust existing on the disk and forming clusters by a predetermined constant.

5. An. information recording/reproduction head for recording information on or reproducing information from a rotary disk, characterized by;
a slider adapted to be held in contact with the disk for traveling, said slider having a contact pad for said contacting, said contact pad having a lateral surface forming an angle smaller than 90 degrees with a disk-opposing surface thereof, said lateral surface having thereon a groove for collecting and holding dust existing on the disk, said groove having a layer of an organic substance formed therein for attracting dust for adhesion, wherein a ridge formed by said lateral surface and said disk-opposing surface has a radius of curvature smaller than a value obtained by multiplying a half diameter of particles of the dust existing on the disk and forming clusters by a predetermined constant.

6. The information recording/reproduction head according to claim 1, wherein said organic substance is expressed by chemical formula of (G-R1)ₓSi(OR)₄₋ₓ, where R1, R and x represent a hydrophilic functional group, a hydrocarbon chain, an integer selected from 1, 2 and 3, respectively, and where G represents a hydrophilic functional group selected from hydrophilic functional groups including OH—(hydroxyl group). NH₃—(amino group). HC(-0-)=CH—(glycidoxy group) and —NCO(isocyanate group), R represents a hydrocarbon chain and R represents a reactive functional group selected from reactive functional groups including —CH₃, —C₂H₅ and —H.

7. The information recording/reproduction head according to claim 4 farther comprising a support spring for supporting said slider and, wherein assuming a force by which said support spring is pressed against said slider is W, a distance between a pressure application point at which said support spring presses said slider and a rearmost contact point at which said contact pad contact the disk is L₁, a distance between a contact point at which a dust cluster contacts said contact pad and said rearmost contact point is L₂ a frictional force applied by said dust cluster to said contact point is Fh, and a variable conversion of A=(WL₁/FhL₂)² is made, given B as expressed by the formula of B=2A+1+(4A(A+1))^{1/2} is said predetermined constant.

8. The information recording/reproduction head according to claim 4, wherein said predetermined constant has a value within a range between 2.6 and 36,000,000.

9. The information recording/reproduction head according to claim 1, wherein the disk is a disk for use in optical recording/reproduction, and said contact pad or said positive pressure surface is provided on a disk-opposing surface thereof with an optical element for raising an intensity of light transmitted through the micro-aperture.

10. The information recording/reproduction head according to claim 1, wherein the disk is a disk for use in magnetic recording/reproduction, and said contact pad or said positive pressure surface is provided on a disk-opposing surface thereof with a magnetic recording/reproduction element.
